(19) United States
(12) Patent Application Publication
(10) Pub. No.: US 2020/0139794 A1
(43) Pub. Date: May 7, 2020

(54) COMPONENT, MOTOR VEHICLE, METHOD FOR THE PRODUCTION OF A COMPONENT AND A METHOD OF OPERATING A MOTOR VEHICLE

(71) Applicants: ElringKlinger AG, Dettingen (DE); ElringKlinger Silicon Valley, Inc., Fremont, CA (US)

(72) Inventors: Simon KNOLL, Menlo Park, CA (US); John KAPCOE, Sunnyvale, CA (US)

(73) Assignees: ElringKlinger AG, Dettingen (DE); ElringKlinger Silicon Valley, Inc., Fremont, CA (US)

(21) Appl. No.: 16/670,390

(22) Filed: Oct. 31, 2019

(30) Foreign Application Priority Data
Nov. 5, 2018 (DE) 10 2018 218 838.6

(51) Int. Cl. B60J 1/20; B60R 16/03; B60R 9/058; B60R 9/05; H02S 20/30; H02S 30/10

(52) U.S. Cl. CPC B60J 1/20; B60R 16/03; H02S 30/10; B60R 9/05; H02S 20/30; B60R 9/058

(57) ABSTRACT

In order to provide a component, in particular, a vehicle component for a motor vehicle which is producible simply and economically and which in particular is mountable reliably, it is proposed that the component comprises the following:
a separating and/or covering element by means of which a first space, in particular an interior of a motor vehicle is separable from a second space, in particular the surroundings of a motor vehicle, and/or by means of which an object, in particular a supporting structure of a motor vehicle is coverable; and/or
a mounting device which comprises one or more mounting elements and by means of which the component is arrangeable on and in particular fixable to an object, in particular a supporting structure of a motor vehicle, wherein the separating and/or covering element comprises one or more cover layers which comprise a plastic material or are formed therefrom and which are transparent at least in sections thereof and/or at least at times.

### RELATED APPLICATION

This application claims the benefit of German patent application No. 10 2018 218 838.6 filed on Nov. 5, 2018, which is incorporated herein by reference in its entirety and for all purposes.

### FIELD OF DISCLOSURE

The present invention relates to a component, in particular a vehicle component for a motor vehicle.

### SUMMARY OF THE INVENTION

The object of the present invention is to provide a component, in particular a vehicle component for a motor vehicle which is producible in a simple and economical manner and in particular is mountable reliably.

In accordance with the invention, this object is achieved by a component, in particular by a vehicle component for a motor vehicle incorporating the features of claim 1.

The component, in particular the vehicle component for a motor vehicle, preferably comprises the following:

a separating and/or covering element by means of which a first space and in particular an interior of a motor vehicle is separable from a second space and in particular the surroundings of a motor vehicle, and/or by means of which an object, in particular a supporting structure of a motor vehicle is coverable; and/or

a mounting device which comprises one or more mounting elements and by means of which the component is arrangeable on and in particular fixable to an object, in particular a supporting structure of a motor vehicle,

wherein the separating and/or covering element comprises one or more cover layers that are transparent at least in sections thereof and/or at least at times and which comprise a plastic material or are formed therefrom.

Consequently, in the context of this description and the accompanying Claims, a transparent cover layer is to be understood in particular as a cover layer that is transparent at least in sections thereof and/or at least at times.

The component is preferably arrangeable directly or indirectly on a supporting structure of a motor vehicle and in particular is fixable thereto by means of the mounting device.

It may be expedient for the component to be screwable to a supporting structure of a motor vehicle by means of the one or more mounting elements of the mounting device, in particular by means of one or more fixing elements, for example, by means of one or more screw elements.

The one or more mounting elements preferably each comprise one or more cut-outs, in particular passage openings, through which fixing elements, in particular, screw elements, are insertible for the purposes of screwing the component to a supporting structure of a motor vehicle.

The separating and/or covering element is preferably formed in multiple layers.

The component is preferably made at least approximately entirely or substantially entirely of a plastic material.

The one or more transparent cover layers comprise in particular a transparent plastic material, for example polycarbonate (PC) and/or polymethyl methacrylate (PMMA), or are formed therefrom.

Furthermore, it is conceivable for the component to be a vehicle component for a rail-mounted vehicle.

In particular, the component is then arrangeable on a supporting structure of the rail-mounted vehicle and in particular is fixable thereto.

The one or more mounting elements of the mounting device are preferably arranged on the separating and/or covering element, in particular, are fixed thereto.

The one or more mounting elements of the mounting device preferably project away from the separating and/or covering element, in particular away from a support element of the separating and/or covering element.

It may be expedient if the one or more mounting elements of the mounting device project transversely and in particular perpendicularly away from the separating and/or covering element.

The separating and/or covering element preferably comprises an inner face and an outer face remote from the inner face.

The outer face of the separating and/or covering element preferably faces the surroundings of a motor vehicle when in a usage and/or an installed state of the component.

The inner face of the separating and/or covering element preferably faces a supporting structure of a motor vehicle and/or an interior of a motor vehicle when in a usage and/or an installed state of the component.

In particular, in the context of this description and the accompanying Claims, a usage and/or an installed state of the component is to be understood as a state in which the component is arranged on a motor vehicle, in particular is fixed thereto.

An outer face of the separating and/or covering element preferably forms an outer face of the component.

The outer face of the separating and/or covering element and/or of the component preferably comprises or forms a Class A surface.

In one configuration of the component, provision is made for the separating and/or covering element to comprise one or more support elements on which one or more and in particular all of the mounting elements of the mounting device are arranged.

The one or more mounting elements are preferably connected to the separating and/or covering element, in particular to the support element and/or to a transparent cover layer by a substance-to-substance bond.

The support element is in particular a transparent cover layer which faces an interior of the motor vehicle when in a usage and/or an installed state of the component.

The one or more mounting elements are preferably moulded or adhered to the support element which, in particular, comprises or forms a transparent cover layer.

It may be particularly expedient for the one or more mounting elements to be manufactured together with the support element in an injection moulding process.

As an alternative thereto, it is conceivable for the one or more mounting elements to be moulded on to the support element in an injection moulding process.

The component preferably comprises at least one transparent cover layer which is connected to the support element.

The support element and the at least one transparent cover layer preferably form a plurality of layers of the separating and/or covering element.

In particular, a transparent cover layer on which the one or more mounting elements are arranged forms a support element.

In this connection, one or more of the support elements are preferably formed to be transparent.

The component preferably comprises at least two transparent cover layers which are connected to one another, wherein at least one transparent cover layer forms a support element.

The transparent cover layer and the support element or two transparent cover layers are preferably connected to one another by a substance-to-substance bond, in particular over at least approximately the entire surface area thereof.

In the context of this description and the accompanying Claims, an “entire surface connection” is to be understood in particular as a connection of two mutually facing surfaces wherein at least approximately 80%, in particular at least approximately 90%, preferably at least approximately 95% of the mutually facing surfaces are connected to one another.

The transparent cover layer and the support element or two transparent cover layers are, for example, adhered, welded or sprayed onto one another and/or are moulded to one another.

As an alternative to a transparent support element, it is conceivable for the separating and/or covering element to comprise one or more non-transparent support elements, wherein the one or more transparent cover layers cover and in particular entirely cover the one or more non-transparent support elements.

Preferably thereby, the one or more transparent cover layers cover at least approximately 80%, in particular at least approximately 90%, preferably at least approximately 95% of a surface of the non-transparent support element.

Preferably, the one or more non-transparent support elements are made of a plastic material, in particular, are made from a non-transparent plastic material. However, it is also conceivable for the one or more non-transparent support elements to be made from a composite material, for example from a fibre-reinforced plastic material and/or a metallic material.

It may be expedient if the component is arrangeable on a supporting structure of a motor vehicle in such a manner that the one or more transparent cover layers face towards the surroundings of the motor vehicle.

If the one or more support elements of the separating and/or covering element each comprise or form a transparent cover layer, provision may be made for the component to be arrangeable on a supporting structure of a motor vehicle in such a way that the one or more support elements face an interior of the motor vehicle.

Preferably thereby, the component forms a vehicle window.

It may be expedient for the component to comprise one or more photovoltaic elements which in particular are arranged on the one or more support elements or are formed thereby.

Preferably, electric current is producible by means of the component due to the provision of one or more photovoltaic elements.

In one embodiment of the component, provision is made for the component to comprise a non-transparent frame element.

Preferably, the non-transparent frame element is arranged on the separating and/or covering element and/or within the separating and/or covering element.

The non-transparent frame element is preferably arranged on a transparent cover layer of the separating and/or covering element and/or surrounds and in particular encloses it.

The non-transparent frame element is preferably in the form of a closed ring. It may be expedient, particularly in a usage or an installed state of the component, if the non-transparent frame element hides the one or more mounting elements of the mounting device.

The non-transparent frame element is preferably arranged between the one or more transparent cover layers of the separating and/or covering element and the one or more mounting elements of the mounting device.

It may be expedient if the non-transparent frame element is arranged on an inner face of the separating and/or covering element and/or within the separating and/or covering element, for example, between two transparent cover layers or between a transparent cover layer and a support element.

Furthermore, it may be expedient for the non-transparent frame element to be arranged between a transparent support element and the one or more mounting elements of the mounting device.

Preferably, the non-transparent frame element is connected to a transparent cover layer and/or to a support element, in particular, by a substance-to-substance bond.

For example, it is conceivable for the non-transparent frame element to be adhered to and/or moulded onto a transparent cover layer and/or onto a support element.

As an alternative or in addition thereto, it is conceivable for a transparent cover layer and/or a support element to be overmoulded with the non-transparent frame element.

The non-transparent frame element preferably comprises a plastic material, in particular, a non-transparent plastic material or consists thereof.

The plastic material of the non-transparent frame element may preferably be coloured, black for example.

Preferably, the non-transparent frame element comprises a foil consisting of a non-transparent material, for example, a non-transparent plastic material, or is formed thereof.

If the non-transparent frame element is arranged between two transparent cover layers or between a transparent cover layer and a support element, provision may be made for the non-transparent frame element to comprise a plastic material, a paper material and/or a metallic material or to consist thereof.

Furthermore, it may be expedient for a transparent cover layer to comprise a re-worked frame element section of the transparent cover layer which forms the non-transparent frame element.

Preferably in connection herewith, the non-transparent frame element is manufactured by subsequently processing the transparent cover layer or a transparent support element.

The transparent cover layer or the transparent support element are preferably non-transparent in the region of the re-worked section of the frame element.

For example, it is conceivable for the non-transparent cover layer or the transparent support element to be subsequently processed in the region of the re-worked section of the frame element by lasers, grinding, etching and/or colouring processes and in particular, to be blackened.

The non-transparent frame element is preferably arranged in particular on a surrounding edge and/or border region of the separating and/or covering element, in particular, on an edge of the transparent cover layer or the transparent support element.

Preferably, connecting leads, antenna devices, heating devices and/or excitation devices for producing sound, which are arranged on or in the separating and/or covering element of the component, are hidden at least partly and in particular entirely by the non-transparent frame element, in particular, in a usage or an installed state of the component.

In one embodiment of the component, provision is made for the component to comprise one or more indicator devices, in particular, one or more display screens, wherein the one or more transparent cover layers cover, in particular, entirely, over the one or more indicator devices.

Preferably, the one or more transparent cover layers cover at least approximately 80%, in particular at least approximately 90% and preferably at least approximately 95% of a surface of the indicator devices.

It may be expedient if the one or more indicator devices form at least approximately 80%, in particular at least approximately 90% and preferably at least approximately 95% of a visible surface of the separating and/or covering element.

An indicator device and in particular a display screen is preferably formed substantially congruently with respect to a transparent cover layer.

The one or more indicator devices, in particular, the one or more display screens preferably adjoin the one or more transparent cover layers, in particular, in shape-matching manner.

As an alternative or in addition thereto, it is possible for the one or more transparent cover layers to adjoin the one or more indicator devices, in particular in shape-matching manner.

It may be expedient if the one or more indicator devices, in particular, the one or more display screens are each arranged entirely between a transparent cover layer and a support element, in particular between a transparent cover layer and a transparent support element.

Preferably, the one or more indicator devices are embedded, in particular entirely, in the separating and/or covering element.

For example, it is conceivable for an indicator device and in particular a display screen to be arranged between two transparent cover layers or a transparent cover layer and a transparent support element of the separating and/or covering element.

Images, symbols and/or characters displayed on a display screen are thereby visible, preferably, from an interior and/or from the surroundings of a motor vehicle.

Images, symbols and/or characters that are visible from the surroundings of a motor vehicle are, in particular, visible as reversed mirror images vis a vis the images, symbols and/or characters that are visible from the interior.

A layered structure of the separating and/or covering element is preferably formed from an outer face to an inner face of the separating and/or covering element as follows: a transparent cover layer; an indicator device, in particular a display screen; a transparent cover layer or a transparent support element.

Furthermore, it is conceivable for the component to comprise a plurality of indicator devices, in particular, display screens that are stacked and/or layered one above the other in the separating and/or covering element.

For example, it is conceivable for two indicator devices, in particular two display screens, to be layered and/or stacked one above the other in each case.

Indicator devices that are layered and/or stacked one above the other are preferably layered and/or stacked indirectly or directly one above the other.

For example, it is conceivable for a transparent separating layer to be arranged between indicator devices that are layered and/or stacked indirectly one above the other.

The indicator devices and in particular the display screens that are layered and/or stacked one above the other are preferably arranged between two transparent cover layers or a transparent cover layer and a transparent support element of the separating and/or covering element.

Images, symbols and/or characters that are displayed on the display screen which faces an interior of a motor vehicle are preferably only visible from the interior of the motor vehicle. Images, symbols and/or characters that are displayed on the display screen which faces the surroundings of a motor vehicle are preferably only visible from the surroundings of the motor vehicle.

Preferably in connection therewith, a layered structure of the separating and/or covering element is formed from an outer face to an inner face of the separating and/or covering element as follows: a transparent cover layer; an indicator device, in particular a display screen; a transparent separating layer; an indicator device, in particular a display screen; a transparent cover layer or a transparent support element.

Indicator devices arranged between two transparent cover layers are preferably connected to the two transparent cover layers by a substance-to-substance bond.

As an alternative or in addition thereto, it is conceivable for indicator devices arranged between two transparent cover layers to be connected to the transparent cover layers in force-locking and/or positive-locking manner.

Indicator devices arranged between a transparent cover layer and a transparent separating layer are preferably connected to the transparent cover layer and the transparent separating layer by a substance-to-substance bond.

As an alternative or in addition thereto, it is conceivable for indicator devices arranged between a transparent cover layer and a transparent separating layer to be connected to the transparent cover layer and the transparent separating layer in force-locking and/or positive-locking manner.

Indicator devices arranged between a transparent cover layer and a transparent support element are preferably connected to the transparent cover layer and the transparent support element by a substance-to-substance bond.

As an alternative or in addition thereto, it is conceivable for indicator devices arranged between a transparent cover layer and a transparent support element to be connected to the transparent cover layer and the transparent support element in force-locking and/or positive-locking manner.

A non-transparent frame element preferably borders directly on a respective indicator device, in particular on a respective display screen, and/or at least partly covers it.

A non-transparent frame element preferably surrounds the one or more indicator devices, in particular, the one or more display screens in the form of a ring.

Preferably, connecting leads of the one or more indicator devices and in particular of the one or more display screens are thus supplyable thereto.

In particular, the connecting leads are concealable by means of the non-transparent frame element.

The one or more display screens preferably each comprise organic respective light emitting diodes (OLED).

It may be expedient if the one or more display screens are OLED display screens.

OLED display screens preferably exhibit a comparatively high transparency.

The one or more indicator devices and in particular the one or more display screens are preferably switchable between an operating state in which in particular images, symbols and/or characters are displayable on the indicator device, and a switched-off state in which the indicator device is switched off.

In a switched off state, the one or more indicator devices and in particular the one or more display screens are preferably substantially transparent and in particular are completely transparent.

Preferably, the one or more indicator devices and in particular the one or more display screens are formed flexibly and in particular adjoin the one or more cover layers in shape-matching manner.

The component preferably comprises a cooling device for cooling one or more display screens, in particular one or more OLED display screens.

It may be expedient if the lifetime of one or more display screens is prolongable by the cooling thereof.

The cooling device is, for example, arranged on the component or integrated into the component, for example, in the separating and/or covering element of the component.

As an alternative or in addition thereto, it is conceivable for one or more OLED display screens to be coolable by means of a motor vehicle's air conditioning system.

In one embodiment of the component, provision is made for the component to comprise one or more excitation devices for producing sound by means of which, in particular, the separating and/or covering element of the component is settable into vibration.

In particular, due to the generation of vibrations by means of the one or more excitation devices sounds and/or noises are producible and/or are reproducible by means of the separating and/or covering element.

For example, the one or more excitation devices each comprise one or more piezo-electric elements by means of which the separating and/or covering element is settable into vibration.

In one embodiment of the component, provision is made for the separating and/or covering element to exhibit a curvature.

A curvature of a surface of an inner face and/or a surface of an outer face of the separating and/or covering element preferably deviates from a plane.

An inner face of the separating and/or covering element is preferably curved concavely or convexly.

An outer face of the separating and/or covering element is preferably curved convexly or concavely.

It may be expedient if all the layers of a separating and/or a covering element and in particular all the transparent cover layers exhibit an at least approximately identical curvature.

Preferably, the one or more display screens exhibit a curvature which corresponds to a curvature of the separating and/or covering element.

In one embodiment of the component, provision is made for the component to comprise a heating device for heating the separating and/or covering element and/or an antenna device.

In particular, the heating device comprises one or more electrical resistance heating elements, in particular, a resistive heating layer and/or a resistive heating wire.

It may be expedient if the heating device forms a window heating device and in particular a windscreen heating device.

In particular, the heating device and/or the antenna device are arranged within the component, for example within the separating and/or covering element.

The heating device and/or the antenna device are preferably embedded in the component, in particular in the separating and/or covering element.

The heating device and/or the antenna device are preferably arranged substantially entirely within the separating and/or covering element.

The heating device and/or the antenna device are preferably entirely covered by means of a transparent frame element.

In one configuration of the component, provision is made for the separating and/or covering element to have an average material thickness of at most approximately 40 mm, in particular, of at most approximately 30 mm, and/or of at least approximately 10 mm, in particular of at least approximately 15 mm.

The separating and/or covering element preferably has an average material thickness within the range of approximately 10 mm up to approximately 40 mm, in particular within the range of approximately 15 mm up to approximately 30 mm.

In one configuration of the component, provision is made for the component to comprise one or more protective coatings for the protection of a respective transparent cover layer of the separating and/or covering element.

It may be expedient if transparent plastic material of the one or more transparent cover layers is protectable from external influences such as contamination and/or scratching for example by means of a respective protective coating.

The protective coating is preferably a scratch and/or impact resistant protective coating.

It may be expedient if the protective coating is adhered, sprayed and/or spread on each transparent cover layer.

Furthermore, it may be expedient for the protective coating to comprise polysiloxane, in particular, a polysiloxane lacquer.

In one configuration of the component, provision is made for the component to be an internal cladding component for a motor vehicle, an external cladding component for a motor vehicle or a vehicle window for a motor vehicle.

The separating and/or covering element preferably forms a cladding element for a motor vehicle.

For example, the component is an instrument panel cladding component or a seat covering component.

It may be expedient for the component to be a windscreen, a vehicle rear window, a vehicle side window and/or a vehicle window for a sliding and/or panorama roof.

Furthermore, it may be expedient for the component to be a bodywork component for a motor vehicle, for example, a wing, a bonnet or a boot lid.

The component in accordance with the invention is suitable in particular for use in a motor vehicle.

Furthermore, the present invention relates to a motor vehicle which comprises one or more components in accordance with the invention.

The motor vehicle in accordance with the invention preferably exhibits individual ones or several of the features and/or advantages described in connection with the component in accordance with the invention.

The one or more components are preferably connected and in particular screwed to a supporting structure of the motor vehicle by means of the one or more mounting elements of the mounting device.

For example, it is conceivable for the motor vehicle to comprise a component according to claim 10, in particular, an internal cladding component, an external cladding component or a vehicle window.

Preferably, the motor vehicle comprises one or more components which comprise one or more indicator devices and in particular one or more display screens.

In one configuration of the motor vehicle, provision is made for the component to be a windscreen and to be arranged on a supporting structure of the motor vehicle and in particular to be fixed thereto by means of the mounting device, wherein the motor vehicle preferably comprises a releasing device for releasing the windscreen in the event of a crash.

The windscreen is releasable from a supporting structure of the motor vehicle by means of the releasing device in the event of a crash.

Preferably, due to the provision of a releasing device for releasing the windscreen, it is possible to prevent an occupant of the motor vehicle being hurled against the windscreen in the event of a crash, in particular, because the windscreen comprises a separating and/or a covering element which incorporates a transparent cover layer that is formed from a plastic material and consequently, in contrast to conventional windscreens made of glass, it preferably does not splinter.

Consequently, due to the releasing device, the windscreen can preferably be released from a supporting structure of the motor vehicle in the event of a crash thereby preferably preventing an occupant of the motor vehicle being hurled against the windscreen in the event of a crash.

Preferably, the safety of the occupants of a motor vehicle can be increased by the provision of the releasing device.

It may be expedient if the releasing device comprises a gas generating device.

In one embodiment of the motor vehicle, provision is made for the motor vehicle to comprise a control device by means of which items of information are displayable on one or more indicator devices and in particular on one or more display screens of the one or more components.

Preferably, indicator devices of the one or more components are controllable in common and/or separately from each other by means of the control device.

For example, it is conceivable for items of information such as items of directional information, speed information, spacing information and/or turning information for example to be displayable on an indicator device of a windscreen of the motor vehicle by means of the control device.

As an alternative or in addition thereto, it is particularly possible for items of information, in particular, turning information, speed information, spacing information and/or braking information to be displayable on indicator devices of external cladding components, vehicle rear windows and/or vehicle side windows by means of the control device.

It may be expedient if the indicator device of an external cladding component, a vehicle rear window and/or a vehicle side window forms an indicator for indicating the direction of travel and/or a braking indicator.

Furthermore, the present invention relates to a method of manufacturing a component, in particular a component in accordance with the invention.

The further object of the present invention is to provide a method of manufacturing a component by means of which a component can, in particular, be mounted reliably and be producible in a simple and economical manner.

In accordance with the invention, this object is achieved by a method of manufacturing a component, in particular a component in accordance with the invention, incorporating the features of claim 14.

The method of manufacturing a component, in particular, a component in accordance with the invention preferably comprises the following: providing an in particular transparent support element;

connecting to the transparent support element, in particular connecting by means of a substance-to-substance bond, one or more mounting elements of a mounting device for the purposes of arranging the component on an object, in particular on a supporting structure of a motor vehicle.

Preferably, for purposes of connecting the one or more mounting elements to the transparent support element they are moulded on or adhered thereto.

In particular, it may be expedient for the one or more mounting elements to be manufactured together with the transparent support element in one injection moulding process.

It is conceivable for the component to be manufactured in a plurality of process steps. It may be particularly expedient thereby for the component to always be arranged in the same half-mould of a shaping tool during the different process steps.

Furthermore, it may be expedient for a non-transparent frame element to first be arranged on the transparent support element before the process of connecting the transparent support element to the one or more mounting elements of the mounting device.

Preferably, the non-transparent frame element is arranged between the transparent support element and the one or more mounting elements of the mounting device.

For example, it is conceivable for the non-transparent frame element to be connected to the transparent support element by a substance-to-substance bond, for example, to be adhered thereto and/or moulded thereon.

As an alternative or in addition thereto, it is conceivable for the transparent support element to be overmoulded with the non-transparent frame element.

Furthermore, it may be expedient for the non-transparent frame element to be produced by re-working the transparent support element.

For example, it is conceivable for the transparent support element to be re-worked by lasers, grinding, an etching and/or colouring process, in particular, blackening.

Preferably, the one or more mounting elements are connected indirectly to the support element by the non-transparent frame element after arranging the non-transparent frame element on the transparent support element.

For example, the non-transparent frame element is first moulded on to the support element, whereafter the one or more mounting elements are then moulded onto the non-transparent frame element.

As an alternative thereto, it is conceivable for the one or more mounting elements to be connected to the support element on a side thereof which is remote from the side on which the non-transparent frame element is arranged.

In one embodiment of the method of manufacturing a component, provision is made for one or more indicator devices, in particular, one or more display screens to be connected to the transparent support element.

The indicator devices and in particular the display screens are preferably placed on the transparent support element in shape-matching manner.

Preferably, an indicator device and in particular a display screen are placed on the transparent support element in shape-matching manner, wherein a transparent cover layer is then connected to the transparent support element, in particular, by a substance-to-substance bond.

The indicator device is preferably connected to the transparent cover layer and the transparent support element by a substance-to-substance bond.

As an alternative or in addition thereto, it is conceivable for the indicator device to be connected to the transparent cover layer and the support element in force-locking and/or positive-locking manner.

In one configuration of the method of manufacturing a component, provision is made for a plurality of indicator devices and in particular display screens to be layered and/or stacked one above the other.

Indicator devices that are layered one above the other are preferably layered and/or stacked directly or indirectly above one another.

For example, it is conceivable for a transparent separating layer to be arranged between indicator devices that are layered and/or stacked indirectly one above the other.

The transparent separating layer is preferably connected to the transparent support element and/or to a transparent cover layer by a substance-to-substance bond.

Furthermore, it is conceivable for the transparent separating layer to be connected to the respective indicator devices that are layered above each other and/or stacked one above the other by means of a substance-to-substance bond and/or in a positive-locking manner.

In one configuration of the method of manufacturing a component, connecting leads, antenna devices, heating devices and/or excitation devices are arranged on the transparent support element and/or on the transparent cover layer and/or on the transparent separating layer in such a manner that the connecting leads, antenna devices, heating devices and/or excitation devices are hidden at least partly and in particular entirely by the non-transparent frame element, in particular, in a usage or an installed state of the component.

Connecting leads, antenna devices, heating devices and/or excitation devices are arranged in particular on a side of the non-transparent frame element that is remote from the support element and/or the transparent cover layers.

The method in accordance with the invention of manufacturing a component preferably exhibits individual ones or several of the features and/or advantages described in connection with the component in accordance with the invention and/or the motor vehicle in accordance with the invention.

Furthermore, the present invention relates to a method of operating a motor vehicle in accordance with the invention.

The method in accordance with the invention of operating a motor vehicle in accordance with the invention preferably comprises the following: displaying items of information on one or more indicator devices and in particular on one or more display screens of the one or more components of the motor vehicle.

The items of information displayed on the indicator devices comprise in particular one or more of the following items of information: information regarding the direction of travel, speed information, spacing information, turning information, images, videos (moving images).

For example, provision can be made for the items of information to be displayed only on an inner face of the separating and/or covering element of a respective component, in particular, when the component is a vehicle window.

In connection therewith however, it is possible in particular that the items of information that are only displayed on the inner face of the separating and/or covering element are visible from an outer face of the separating and/or covering element as a reversed mirror-image.

For example, it may be expedient thereby for the items of information to comprise items of direction information, speed information, items of spacing information, images and/or videos (moving images).

Furthermore, provision can be made for the items of information to be displayed only on an outer face of the separating and/or covering element of a respective component, in particular if the component is an external cladding component of the motor vehicle.

Items of information displayed on an outer face of the separating and/or covering element of a respective component preferably comprise items of turning information and/or braking information. Preferably hereby, components in accordance with the invention are usable as braking indicators and/or direction of travel indicators.

Furthermore, it is conceivable for information displayed on an outer face of the separating and/or covering element of a respective component to comprise images or videos (moving images). Consequently, components in accordance with the invention are preferably also usable for the display of advertisements on a motor vehicle.

Furthermore, it may be expedient for items of information on indicator devices which are layered and/or stacked one above the other in a separating and/or covering element of a component to be displayed on an inner face of the separating and/or covering element and/or on an outer face of the separating and/or covering element.

For example, it is conceivable for the component to be a windscreen and for videos (moving images) to be displayed on the inner face of the windscreen.

Preferably, items of information are preferably displayed over at least approximately 80%, in particular, over at least approximately 90%, preferably over at least approximately 95% of a visible surface of a separating and/or covering element of a respective component.

Furthermore, it is conceivable for differing items of information to be displayed on different regions of an outer face and/or an inner face of a separating and/or a covering element.

For example, a region that is being filmed by means of a camera of the motor vehicle and in particular a region located in front of the motor vehicle is displayed on a driver's side region of a windscreen, in particular without time delay.

In the context of the description and the accompanying Claims, the phrase “without time delay” is to be understood in particular as a time delay which is due only to the type of data and/or signal transmission system during a direct transmission of data and/or signals.

For example, a video and in particular a feature film is displayed on a region of a windscreen on the front-seat-passenger's side.

Furthermore, in the case of an autonomously driven vehicle, it is conceivable for a video, in particular the same video or mutually differing videos, to be displayed on an inner face on the driver's side and/or the front-seat-passenger's side of the vehicle.

Furthermore, in one arrangement of the method of operating a motor vehicle, provision may be made for separating and/or covering elements of components of the motor vehicle to be set into vibration for producing sound by means of one or more respective excitation devices.

Preferably, different sound tracks for different passengers are reproduced by means of different components.

Further features and/or advantages of the invention form the subject of the following description and the graphical illustration of exemplary embodiments.

### BRIEF DESCRIPTION OF THE DRAWINGS

FIG. 1 shows a schematic side view of an exemplary embodiment of a motor vehicle;

FIG. 2 a schematic frontal view of the motor vehicle depicted in FIG. 1 as viewed in the direction of the arrow 2 in FIG. 1;

FIG. 3 a schematic longitudinal section through an exemplary embodiment of a component, in particular, a windscreen;

FIG. 4 an enlarged illustration of the region IV in FIG. 3;

FIG. 5 a schematic longitudinal section through an exemplary embodiment of a component, in particular, a windscreen;

FIG. 6 an enlarged illustration of the region VI in FIG. 5;

FIG. 7 a schematic longitudinal section through an exemplary embodiment of a component, in particular, a windscreen;

FIG. 8 an enlarged illustration of the region VIII in FIG. 7;

FIGS. 9 to 11 different process steps of an exemplary embodiment of a method for making the component depicted in FIG. 5;

FIGS. 12 to 16 different process steps of an exemplary embodiment of a method for making the component depicted in FIG. 7;

FIG. 17 a schematic frontal view of the component depicted in FIG. 5 as viewed in the direction of the arrow 17 in FIG. 5;

FIG. 18 a frontal view of the component corresponding to FIG. 17, wherein different items of information are displayed on an indicator device on the driver's side and the front-seat-passenger's side of the vehicle;

FIG. 19 an enlarged illustration of the region XIX in FIG. 17; and

FIG. 20 a seat device for a motor vehicle depicted in FIG. 1 which comprises a component depicted in FIG. 5.

Similar or functionally equivalent elements are provided with the same reference symbols in all of the Figures.

### DETAILED DESCRIPTION OF THE DRAWINGS

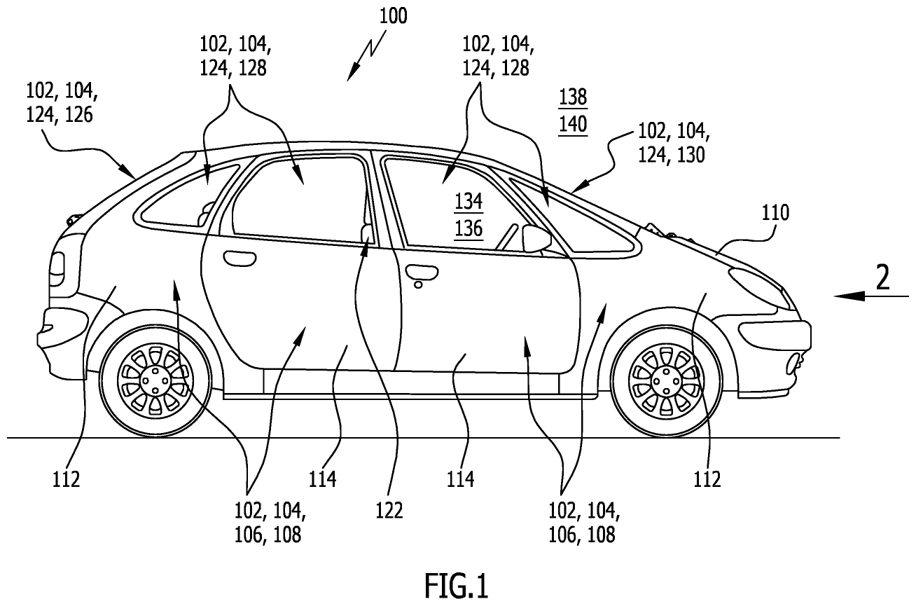

FIG. 1 shows a motor vehicle which is referenced as a whole by 100.

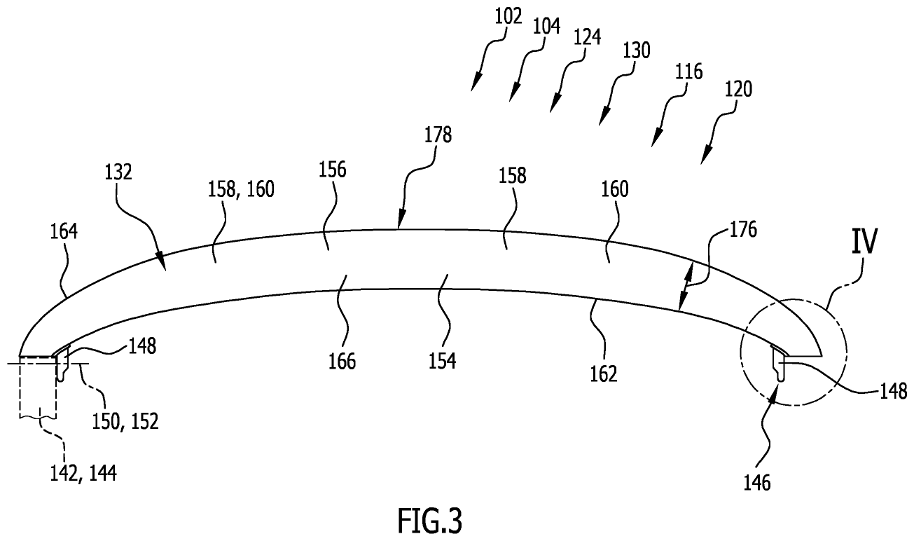

The motor vehicle 100 preferably comprises a plurality of components 102 that are illustrated in FIGS. 3 to 20, in particular vehicle components 104 for the motor vehicle 100.

The components 102 illustrated in FIGS. 3 to 20 can, for example, be external cladding components 106, in particular bodywork components 108.

In particular, it is conceivable for the components 102 illustrated in FIGS. 3 to 20 to form a bonnet 110, a wing 112 or a door 114 of the motor vehicle 100.

Furthermore, it is conceivable for the components 102 illustrated in FIGS. 3 to 20 to be internal cladding components 116, for example dashboard cladding components 118 and/or seat covering components 120 of a seat device 122 that is illustrated in FIGS. 1, 2 and 20.

Furthermore, it may be expedient for the components 102 illustrated in FIGS. 3 to 20 to be vehicle windows 124, in particular rear windows 126 of the vehicle, vehicle side windows 128, vehicle windows 124 for a sliding and/or a panorama roof or a windscreen 130.

The components 102 illustrated in FIGS. 3 to 20 preferably each comprise a separating and/or covering element 132.

A first space 134, in particular an interior 136 of the motor vehicle 100 is preferably separable from a second space 138, in particular from the surroundings 140 of the motor vehicle 100 by means of the separating and/or covering element 132.

As an alternative or in addition thereto, an object 142 and in particular a supporting structure 144 of the motor vehicle 100 is coverable by means of the separating and/or covering element 132 (c.f. FIGS. 3, 5 and 7).

The components 102 illustrated in FIGS. 3 to 20 preferably each comprise a mounting device 146 which comprises one or more mounting elements 148.

The components 102 are preferably arrangeable on an object 142, in particular, on a supporting structure 144 of the motor vehicle 100 and in particular are fixable thereto by means of the mounting device 146 (c.f. FIGS. 3, 5 and 7).

The components 102 are preferably arrangeable directly or indirectly on the supporting structure 144 of the motor vehicle 100 and in particular are fixable thereto by means of the mounting device 146.

For example, provision may be made for each component 102 to be screwed or to be capable of being screwed to the supporting structure 144 of the motor vehicle 100 by means of the mounting elements 148 of the mounting device 146, in particular, by means of a plurality of fixing elements 150 such as by means of a plurality of screw elements 152 for example.

In connection therewith, the mounting elements 148 of the mounting device 146 preferably each comprise a plurality of cut-outs, which are in the form of passage openings in particular, wherein the fixing elements 150 and in particular the screw elements 152 are insertible through the passage openings for the purposes of screwing the components 102 to the supporting structure 144 of the motor vehicle 100.

Preferably, the separating and/or covering element 132 of the components 102 each comprise one or more cover layers 154 which are transparent at least in sections thereof and/or at least at times.

The transparent cover layers 154 preferably comprise a plastic material 156, in particular, a transparent plastic material 158 or are formed therefrom.

The transparent plastic material 158 is polycarbonate (PC) 160 or polymethyl methacrylate (PMMA) for example.

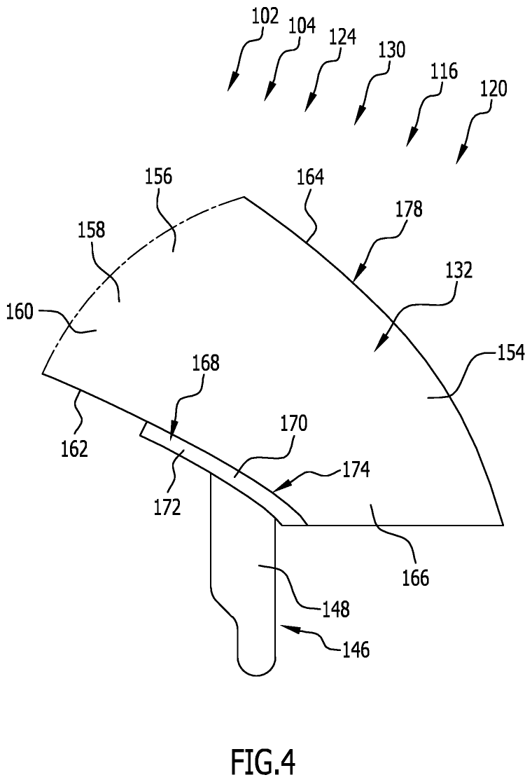

The exemplary embodiment of the component 102 that is illustrated in FIGS. 3 and 4 preferably comprises a separating and/or covering element 132 which consists substantially of only a transparent cover layer 154.

In particular, it is conceivable for the exemplary embodiment of the component 102 that is illustrated in FIGS. 3 and 4 to be made at least approximately entirely or substantially entirely of a plastic material 156.

The separating and/or covering element 132 of the component 102 preferably comprises an inner face 162 and an outer face 164 remote from the inner face 162.

The outer face 164 of the separating and/or covering element 132 preferably forms an outer face 164 of the component 102 and preferably comprises a Class A surface.

The outer face 164 of the separating and/or covering element 132 and/or of the component 102 preferably faces the surroundings 140 of the motor vehicle 100 when in a usage or an installed state of the component 102.

The inner face 162 of the separating and/or covering element 132 and/or of the component 102 preferably faces a supporting structure 144 of the motor vehicle 100 or the interior 136 of the motor vehicle 100 in a usage or an installed state of the component 102.

The separating and/or covering element 132 in the exemplary embodiment of the component 102 illustrated in FIGS. 3 and 4 preferably exhibits a curvature.

In particular, a surface of the inner face 162 of the separating and/or covering element 132 is curved concavely.

A surface of the outer face 164 of the separating and/or covering element 132 is preferably curved convexly.

In the exemplary embodiment of the component 102 that is illustrated in FIGS. 3 and 4, the mounting elements 148 of the mounting device 146 are arranged on the separating and/or covering element 132 and in particular are fixed thereto.

In connection therewith, the mounting elements 148 of the mounting device 146 preferably project away from the separating and/or covering element 132, in particular at least approximately perpendicularly.

It may be expedient for the separating and/or covering element 132 to comprise a support element 166 on which the mounting elements 148 of the mounting device 146 are arranged.

In the exemplary embodiment of the component 102 that is illustrated in FIGS. 3 and 4, the transparent cover layer 154 forms the support element 166.

Consequently. the support element 166 is preferably a transparent support element.

The support element 166 in the exemplary embodiment illustrated in FIGS. 3 and 4 is preferably connected, in particular indirectly, to the mounting elements 148 of the mounting device 146 by a substance-to-substance bond.

The mounting elements 148 are preferably moulded on or adhered to the support element 166.

As an alternative thereto, it is conceivable for the mounting elements 148 to be manufactured together with the support element 166 in an injection moulding process.

Furthermore, the exemplary embodiment of the component 102 illustrated in FIGS. 3 and 4 preferably comprises a non-transparent frame element 168 which comprises in particular a non-transparent plastic material 170 or consists thereof.

The non-transparent frame element 168 of the component 102 is preferably arranged between the transparent cover layer 154 or the support element 166 of the separating and/or covering element 132 and the mounting elements 148 of the mounting device 146.

In the exemplary embodiment of the component 102 that is illustrated FIGS. 3 and 4, the non-transparent frame element 168 is arranged in particular on the inner face 162 of the separating and/or covering element 132.

The non-transparent frame element 168 is preferably connected to the transparent cover layer 154 and/or to the support element 166, in particular by a substance-to-substance bond.

For example, it is conceivable for the non-transparent frame element 168 to be adhered to and/or moulded onto the transparent cover layer 154 and in particular to the support element 166.

The non-transparent plastic material 170 of the non-transparent frame element 168 is preferably coloured, black for example.

It may be expedient for the non-transparent frame element 168 to comprise a foil 172 consisting of non-transparent material, for example a non-transparent plastic material 170, or to be formed thereof.

Furthermore, provision may be made for the non-transparent frame element 168 to be manufactured by re-working the transparent cover layer 154 or the transparent support element 166.

The transparent cover layer 154 or the transparent support element 166 are preferably then non-transparent in the region of a re-worked section 174 of the frame element.

For example, it is conceivable for the transparent cover layer 154 or the support element 166 in the region of the re-worked section 174 of the frame element to be re-worked by lasers, grinding, etching and/or colouring processes, in particular, blackened.

In the exemplary embodiment illustrated in FIGS. 3 and 4, the component 102 preferably forms a vehicle window 124 and in particular a windscreen 130.

The separating and/or covering element 132 preferably exhibits an average material thickness 176 of at most approximately 40 mm, in particular of at most approximately 30 mm and/or of at least approximately 10 mm, in particular of at least approximately 15 mm.

In particular, the separating and/or covering element 132 exhibits an average material thickness 176 in the range of approximately 10 mm up to approximately 40 mm, in particular in the range of approximately 15 mm up to approximately 30 mm.

Preferably, the exemplary embodiment of the component 102 that is illustrated in FIGS. 3 and 4 comprises a protective coating 178 for protecting the transparent cover layer 154 of the separating and/or covering element 132.

It may be expedient for the protective coating 178 to be arranged on a surface of the outer face 164 of the separating and/or covering element 132.

The protective coating 178 is preferably scratch and/or impact resistant so that the transparent plastic material 158 and in particular the polycarbonate of the transparent cover layer 154 can be protected by means of the protective coating 178 from external influences such as contamination and/or scratching for example.

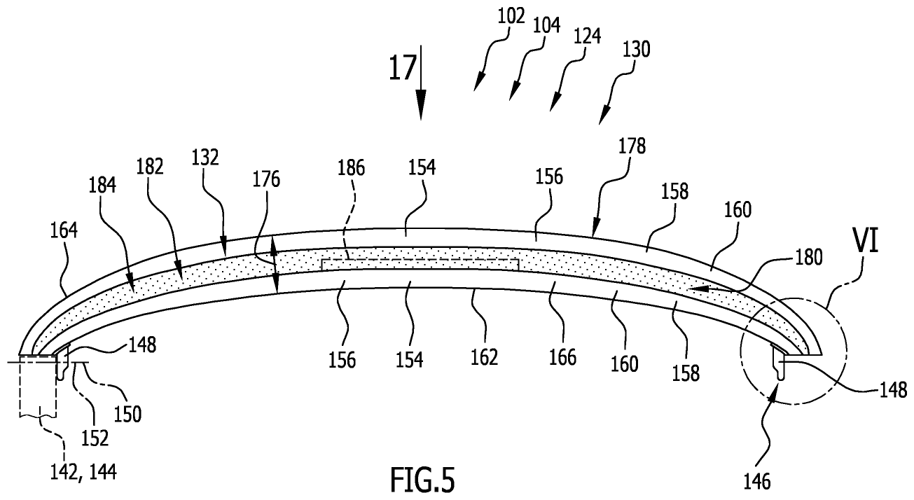

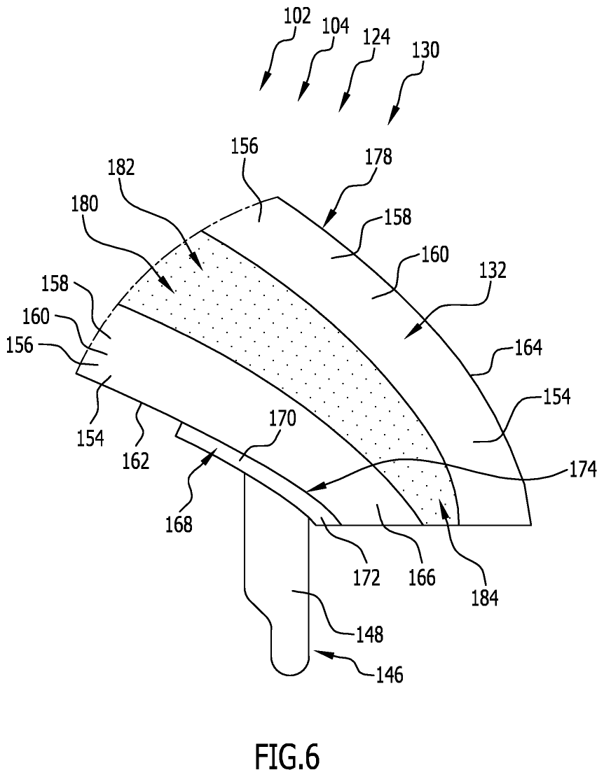

A further exemplary embodiment of the component 102 is illustrated in FIGS. 5 and 6.

The exemplary embodiment of the component 102 that is illustrated in FIGS. 5 and 6 differs from the exemplary embodiment of the component 102 illustrated in FIGS. 3 and 4 basically in that the separating and/or covering element 132 is formed of multiple layers.

The component 102 preferably comprises an indicator device 180 and in particular a display screen 182.

The display screen 182 is preferably a so-called OLED display screen 184 and preferably comprises a plurality of organic light emitting diodes.

Preferably, the separating and/or covering element 132 of the exemplary embodiment of the component 102 illustrated in FIGS. 5 and 6 comprises a transparent cover layer 154 which forms the transparent support element 166 on which the mounting elements 148 are arranged, as well as a transparent cover layer 154 which preferably entirely covers the indicator device 180 and in particular the display screen 182.

The transparent support element 166, the indicator device 180 and in particular the display screen 182 and the transparent cover layer 184 preferably adjoin each other in shape-matching manner.

The indicator device 180, in particular the display screen 182, is preferably arranged entirely between the transparent cover layer 154 and the transparent support element 166.

It may be expedient for the indicator device 180 and in particular the display screen 182 to be embedded in the separating and/or covering element 132.

The indicator device 180 and in particular the display screen 182 of the exemplary embodiment of the component 102 illustrated in FIGS. 5 and 6 is preferably switchable between an operational state and an off state.

In the operational state of the indicator device 180 and in particular of the display screen 182, images, symbols and/or characters are preferably displayable on the indicator device 180 and in particular on the display screen 182.

In the switched off state of the indicator device 180 and in particular of the display screen 182, the latter is preferably substantially and in particular completely transparent.

In connection therewith, the component 102 preferably forms a vehicle window 124, in particular, a windscreen 130 of the motor vehicle 100.

In a further not graphically illustrated exemplary embodiment of the component 102, provision may be made for the support element 166 to be non transparent and for example to comprise a non-transparent plastic material 170 or to be formed thereof.

Furthermore, it is conceivable for the support element 166 to be formed of a metallic material.

An exemplary embodiment of the component 102 of this type preferably forms an external cladding component 106, in particular a bodywork component 108 of the motor vehicle 100, for example a bonnet 110.

Furthermore, provision may be made for the component to comprise a photovoltaic element 186 which is arranged on the support element 166.

Due to the provision of the photovoltaic element 186, electric current is preferably producible by means of the component 102.

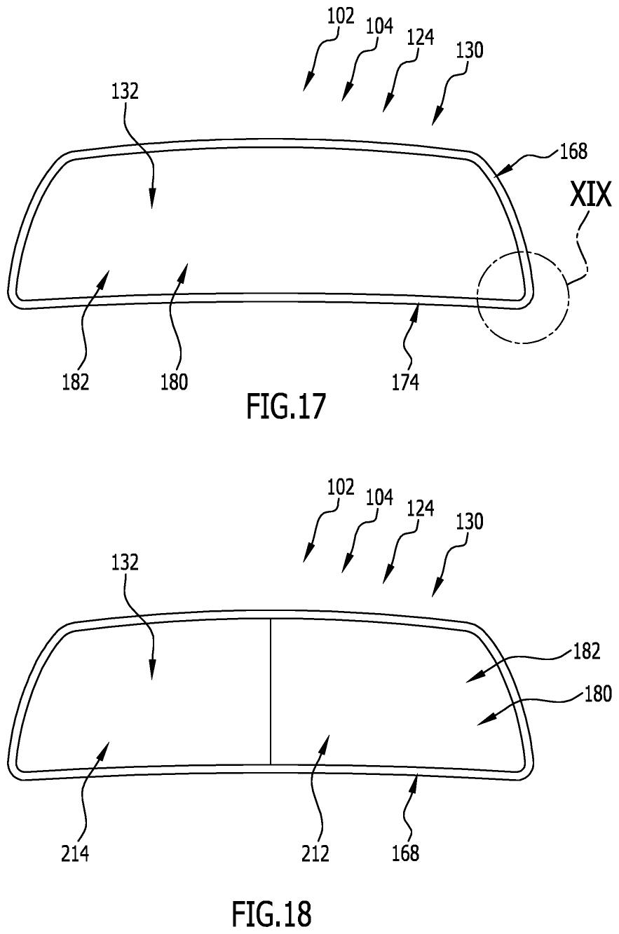

The exemplary embodiment of the component 102 that is illustrated in FIGS. 5 and 6 is illustrated in FIG. 17 in the direction of the arrow 17 in FIG. 5.

The non-transparent frame element 168 is clearly visible therein.

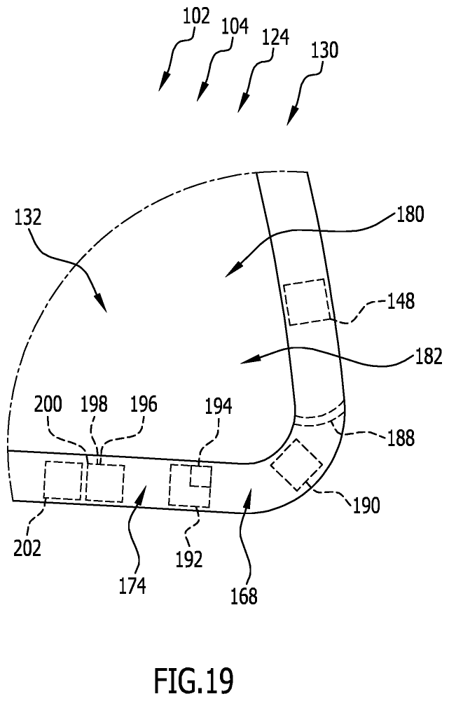

It may be expedient if connecting leads 188 of the indicator device 180 and in particular of the display screen 182 are hidden by the non-transparent frame element 168 (c.f. FIG. 19).

As is clearly apparent from FIG. 19, the component 102 preferably comprises a cooling device 190 for cooling the indicator device 180 and in particular the display screen 182.

Preferably, the lifetime of the display screen 182 can be extended by the provision of the cooling device 190.

Furthermore, it may be expedient for the component 102 to comprise one or more excitation devices 192 for producing sound.

Preferably, the separating and/or covering element 132 of the component 102 is settable into vibration by means of the excitation device 192.

The excitation device 192 preferably comprises one or more piezo-electric elements 194 by means of which the separating and/or covering element 132 is settable into vibration.

Due to the vibrations of the separating and/or covering element 132, sounds and/or noises are preferably producible by means of the excitation device 192.

Furthermore, it is clearly apparent from FIG. 19 that the component 102 preferably comprises a heating device 196 for heating the separating and/or covering element 132.

In particular, the heating device 196 comprises one or more electrical resistance heating elements, in particular a resistive heating layer and/or a resistive heating wire.

In particular, the heating device 196 forms a window heating device 198, in particular a windscreen heating device 200.

Furthermore, the component 102 preferably comprises an antenna device 202.

It may be expedient for the cooling device 190, the excitation device 192, the heating device 196 and/or the antenna device 202 to be embedded in the separating and/or covering element 132.

Preferably hereby, the cooling device 190, the excitation device 192, the heating device 196 and/or the antenna device 202 are arranged between the support element 166 and the transparent cover layer 154.

In particular, in the exemplary embodiment of the component 102 that is illustrated in FIGS. 5, 6, 17 and 19, provision may be made for the mounting elements 148, the connecting lead 188, the cooling device 190, the excitation device 192, the heating device 196 and/or the antenna device 202 to be arranged on the support element 166 and/or on the transparent cover layer 154 in such a manner that they are entirely hidden by the non-transparent frame element 168, in particular in a usage or an installed state of the component 102.

In connection therewith, the connecting lead 188, the cooling device 190, the excitation device 192, the heating device 196 and/or the antenna device 202 are, for example, arranged on the side of the non-transparent frame element 168 remote from the support element 166 and/or the transparent cover layer 154.

In all other respects the exemplary embodiment of the component 102 that is illustrated in FIGS. 5, 6, 17 and 19 corresponds in regard to the construction and functioning thereof to the exemplary embodiment illustrated in FIGS. 3 and 4 so that to that extent reference should be made to the preceding description thereof.

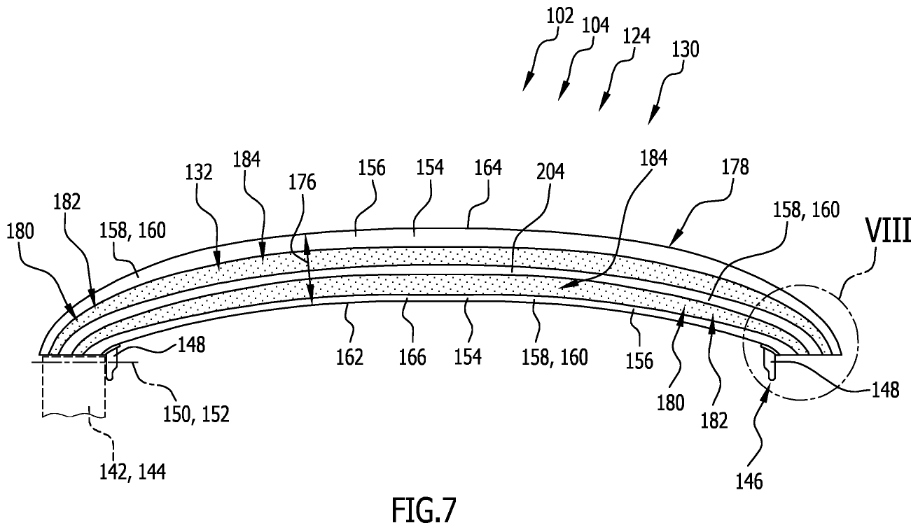

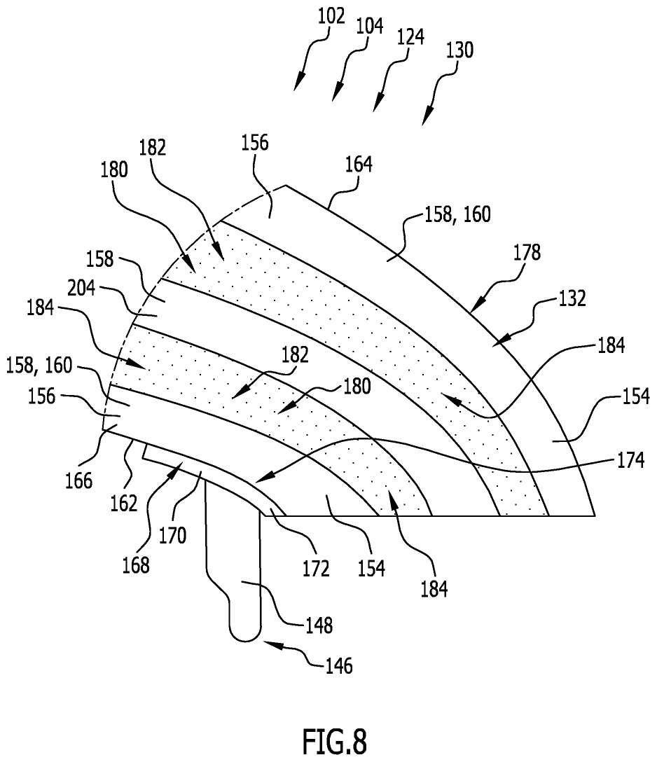

The exemplary embodiment of the component 102 that is illustrated in FIGS. 7 and 8 differs from the exemplary embodiment of the component 102 illustrated in FIGS. 5, 6, 17 and 19 basically in that the component 102 comprises a plurality of indicator devices 180 that are layered and/or stacked one above the other and in particular a plurality of display screens 182 that are layered and/or stacked one above the other in the separating and/or covering element 132.

The indicator devices 180 and in particular the display screens 182 are preferably layered and/or stacked indirectly one above the other.

In particular, provision may be made for a transparent separating layer 204 to be arranged between two indicator devices 180 that are layered and/or stacked indirectly one above the other and in particular between two display screens 182 that are layered and/or stacked indirectly one above the other.

In connection therewith, the indicator devices 180 and in particular the display screens 182 that are layered and/or stacked one above the other are preferably arranged between two transparent cover layers 154 or between a transparent cover layer 154 and a transparent support element 166 of the separating and/or covering element 132.

The transparent separating layer 204 preferably comprises a plastic material 156, in particular, a transparent plastic material 158, for example polycarbonate (PC) 160.

Preferably in connection with, the layered structure of the separating and/or covering element 132 from the outer face 164 to the inner face 162 of the separating and/or covering element 132 is as follows: a transparent cover layer 154; an indicator device 180 and in particular a display screen 182; a transparent separating layer 204; an indicator device 180 in particular a display screen 182; a transparent cover layer 154 or a transparent support element 166.

The indicator devices 180 and in particular the display screens 182 that are arranged between a transparent cover layer 154 or the transparent support element 166 and the transparent separating layer of 204 are, for example, connected to the transparent cover layer 154 or to the transparent support element 166 and the transparent separating layer 204 by a substance-to-substance bond.

As an alternative or in addition thereto, it is conceivable for the indicator devices 180 and in particular the display screens 182 that are arranged between the transparent cover layer 154 or the transparent support element 166 and the transparent separating layer 204 to be connected to the transparent cover layer 154 or to the transparent support element 166 and the transparent separating layer 204 in force-locking and/or positive-locking manner.

The non-transparent frame element 168 preferably borders directly on the indicator device 180, in particular on the display screens 182.

It may be expedient for the non-transparent frame element 168 to surround the indicator devices 180 and in particular the display screens 182 in closed ring-like manner.

In all other respects the exemplary embodiment of the component 102 that is illustrated in FIGS. 7 and 8 corresponds in regard to the construction and functioning thereof to the exemplary embodiment illustrated in FIGS. 5, 6, 17 and 19 so that to that extent reference should be made to the preceding description thereof.

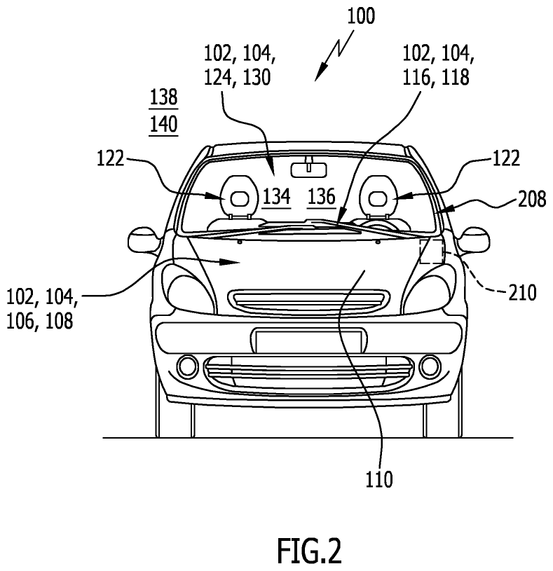

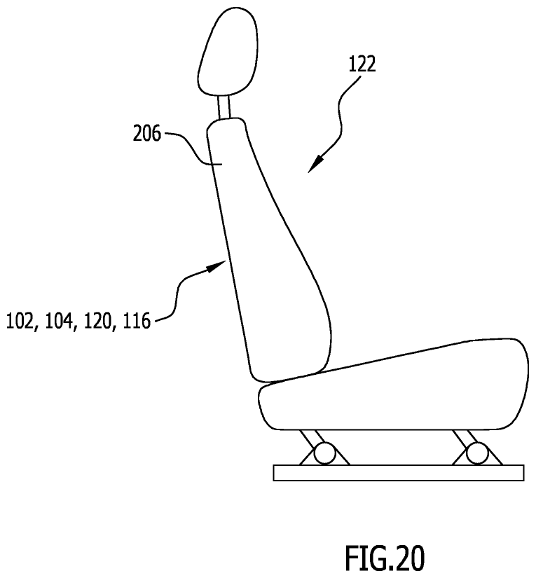

The exemplary embodiment of the motor vehicle 100 illustrated in FIGS. 1 and 2 comprises a seat device 122 which is illustrated in FIG. 20 for example.

For example, it is conceivable for the seat device 122 to comprise an exemplary embodiment of the component 102 that is illustrated in FIGS. 5, 6, 17 and 19.

In connection therewith, the component 102 is preferably an internal cladding component 116.

The component 102 preferably comprises a non-transparent support element 166 and is arranged on the rear side of a backrest 206 for example.

The component 102 preferably forms a seat covering component 120.

Preferably, the motor vehicle 100 comprises a releasing device 208, which is merely schematically illustrated in FIG. 2 by means of an arrow, for the purposes of releasing the component 102 that is in the form of a windscreen 130 in the event of a crash.

The windscreen 130 is preferably releasable from a supporting structure of the motor vehicle by means of the releasing device 208.

The releasing device 208 preferably comprises a gas generating device 210.

Due to the provision of the releasing device 208, an occupant of the motor vehicle can preferably be prevented from being hurled against the windscreen 130 in the event of a crash.

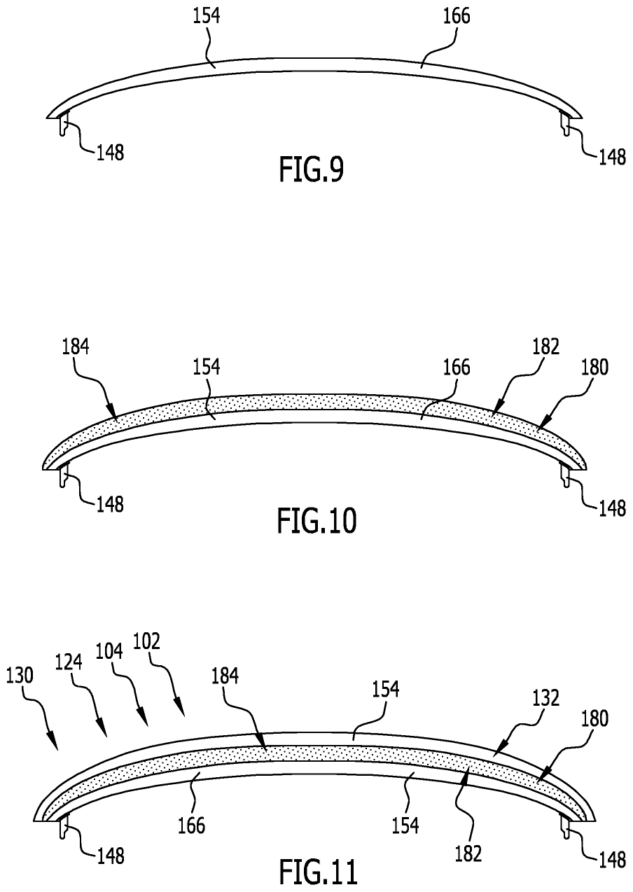

Various process steps for the manufacture of the exemplary embodiment of the component 102 that is illustrated in FIGS. 5, 6, 17 and 19 are illustrated in FIGS. 9 to 11.

In a first process step, a support element 166 and in particular a transparent support element 166 and/or a transparent cover layer 154 are preferably inserted into a shaping tool that is not graphically illustrated in the Figures or is manufactured therein by an injection moulding process for example.

It may be expedient if the support element 166 and/or the transparent cover layer 154 is remodelled in the shaping tool in such a way that the support element 166 or the transparent cover layer 154 achieve the curvature that is illustrated in FIG. 9.

In a process step following thereon, provision may be made for the non-transparent frame element 168 to be connected to the support element 166 or to the transparent cover layer 154, for example by moulding and/or adhering the non-transparent frame element 168 onto the support element 166 or the transparent cover layer 154.

Preferably, the mounting elements 148 of the mounting device 146 are then connected to the support element 166 or to the transparent cover layer 154 by a substance-to-substance bond.

In particular in connection therewith, the mounting elements 148 are connected indirectly to the support element 166 or to the transparent cover layer 154 by means of the non-transparent frame element 168 by a substance-to-substance bond, in particular, in such a manner that the mounting elements 148 are hidden from the outer face 164 of the separating and/or covering element 132 by means of the non-transparent frame element 168.

FIG. 10 shows that an indicator device 180 such as a display screen 182 for example is arranged on the support element 166 or on the transparent cover layer 154 and, for example, is connected to the support element 166 or to the transparent cover layer 154 by a substance-to-substance bond.

It may be expedient for the support element 166 or the transparent cover layer 154 when arranging the indicator device 180 in a shaping tool to be arranged for example in the shaping tool in which the mounting elements 148 were moulded onto the support element 166 or the transparent cover layer 154.

FIG. 11 shows that a transparent cover layer 154 is located on the indicator device 180 and in particular on the display screen 182, and that it preferably entirely covers the indicator device 180, in particular the display screen 182.

It may be expedient for the transparent cover layer 154 to be connected to the indicator device 180 by a substance-to-substance bond.

As an alternative or in addition thereto, provision may be made for the transparent cover layer 154 to be connected to the support element 166 or the transparent cover layer 154 by a substance-to-substance bond so that the indicator device 180 and in particular the display screen 182 is furthermore arranged in force-locking and/or positive-locking manner between the support element 166 or the transparent cover layer 154 and the transparent cover layer 154 located on the outer face 162.

From the outer face 164 to the inner face 162, the transparent cover layer 154, the indicator device 180 and in particular the display screen 182 and the support element 166 or the transparent cover layer 154 preferably form the separating and/or covering element 132.

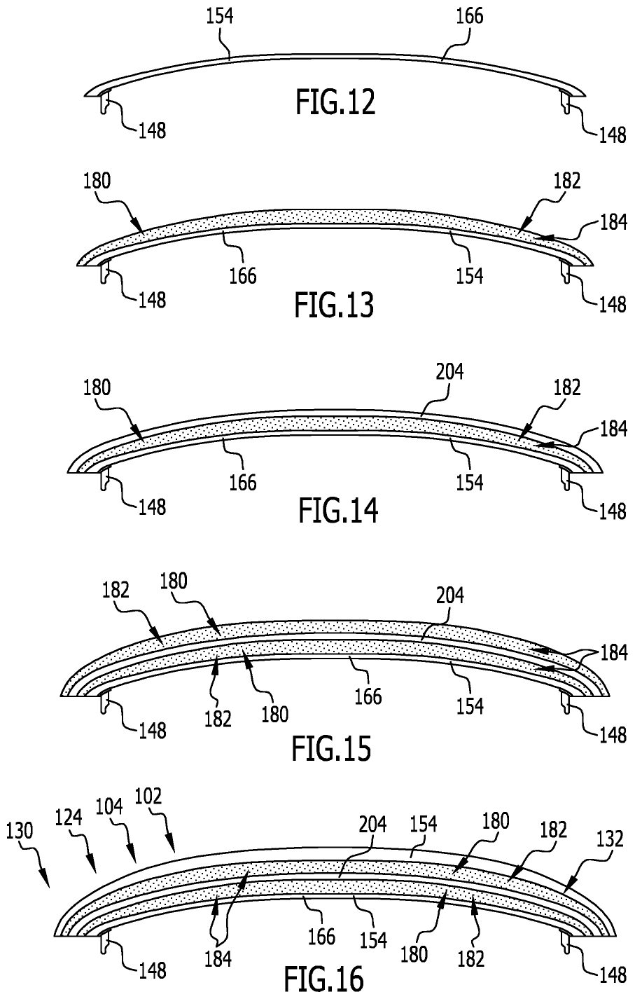

The exemplary embodiment of the method of manufacturing the exemplary embodiment of the component 102 illustrated in FIGS. 7 and 8 which is illustrated in FIGS. 12 to 16 differs from the exemplary embodiment of the method illustrated in FIGS. 9 to 11 basically in that, in the third process step illustrated in FIG. 14, there is arranged on the indicator device 180 a transparent separating layer 204 which preferably entirely covers the indicator device 180 and in particular the display screen 182.

Thereafter, in the process step illustrated in FIG. 15, a further indicator device 180 and in particular a display screen 182 is arranged on the transparent separating layer 204 and in particular, is connected thereto by a substance-to-substance bond.

The two indicator devices 180 and in particular the display screens 182 are thus preferably layered and/or stacked one above the other.

Thereafter, in the process step illustrated in FIG. 16, on the outer face 164, a transparent cover layer 154 is arranged on the indicator device 180 and in particular on the display screen 182 and, in particular, is connected thereto by a substance-to-substance bond.

Furthermore, provision may be made for the transparent cover layer 154, the transparent separating layer 204 and the support element 166 or the transparent cover layer 154 to be respectively connected to one another by a substance-to-substance bond in such a manner that the two indicator devices 180 are also connected thereto in force-locking and/or positive-locking manner.

In the process steps illustrated in FIGS. 12 to 16, it may be expedient for the support element 166 or the transparent cover layer 154 to always be arranged in the same half-mould of a shaping tool.

In all other respects the exemplary embodiment of the method that is illustrated in FIGS. 12 to 16 corresponds to the exemplary embodiment illustrated in FIGS. 9 to 11 so that to that extent reference should be made to the description thereof.

Items of information are preferably displayable on the components 102 of the motor vehicle 100 that is illustrated in FIGS. 1 and 2, in particular, on the vehicle side windows 128, the rear window 126 of the vehicle, the wings 112, the doors 114, the bonnet 110 and the windscreen 130 and, in particular, on the indicator devices 180 of the components 102.

In connection therewith, the items of information displayed on the indicator devices 180 and in particular on the display screens 182 preferably comprise directional information, speed information, spacing information, turning information, images, videos (moving images).

In FIG. 18, there is illustrated a component 102 such as a windscreen 130 for example, wherein a region in front of the motor vehicle 100 that is being filmed by means of cameras of the motor vehicle 100 is displayed on a driver's side region 212 of the windscreen 130, in particular, without any time delay.

At the same time, a video for example and in particular a feature film is displayed on a front seat passenger's side region 214 of the windscreen 130.

Furthermore, in the case of an autonomously driven motor vehicle 100, it is conceivable for one or more videos to be displayed on both the driver's side region 212 and on the front seat passenger's side region 214 of the windscreen 130.

It may be expedient for the driver's side region 212 and the front seat passenger's side region 214 of the windscreen 130 to be used together for the reproduction of a video.

Preferably, further separating and/or covering elements 132 of the components 102 are set into vibration by means of the respective excitation devices 192 for producing sound so that sounds and/or noises relating to the reproduced videos are also reproduced.

For example, it is conceivable that different sound tracks are reproduced for different occupants of the motor vehicle by means of different components 102.

Overall, a component 102 and in particular a vehicle component 104 for a motor vehicle 100 can be made available which is producible in a simple and economical manner and which in particular can be reliably mounted.

1. A component (102), in particular a vehicle component (104) for a motor vehicle (100), wherein the component (102) comprises the following:
a separating and/or covering element (132) by means of which a first space (134), in particular an interior (136) of a motor vehicle (100) is separable from a second space (138), in particular the surroundings (140) of a motor vehicle (100), and/or by means of which an object (142), in particular a supporting structure (144) of a motor vehicle (100) is coverable; and/or
a mounting device (146) which comprises one or more mounting elements (148) and by means of which the component (102) is arrangeable and in particular fixable onto an object (142), in particular a supporting structure (144) of a motor vehicle (100),
wherein the separating and/or covering element (132) comprises one or more cover layers (154) which comprise a plastic material (156) or are formed thereof and which are transparent at least in sections thereof and/or at least at times.

2. The component (102) according to claim 1, characterized in that the separating and/or covering element (132) comprises one or more support elements (166) on which one or more, and in particular all, mounting elements (148) of the mounting device (146) are arranged.

3. The component (102) according to claim 1, characterized in that the component (102) comprises a non-transparent frame element (168).

4. The component (102) according to claim 1, characterized in that the component (102) comprises one or more indicator devices (180), in particular, one or more display screens (182), wherein the one or more transparent cover layers (154) cover the one or more indicator devices (180) and in particular cover them completely.

5. The component (102) according to claim 1, characterized in that the component (102) comprises one or more excitation devices (192) for producing sound by means of which in particular the separating and/or covering element (132) of the component (102) is settable into vibration.

6. The component (102) according to claim 1, characterized in that the separating and/or covering element (132) has a curvature.

7. The component (102) according to claim 1, characterized in that the component (102) comprises a heating device (196) for heating the separating and/or covering element (132) and/or an antenna device (202).

8. The component (102) according to claim 1, characterized in that the separating and/or covering element (132) has an average material thickness (176) of at most approximately 40 mm, in particular of at most approximately 30 mm, and/or of at least approximately 10 mm, in particular of at least approximately 15 mm.

9. The component (102) according to claim 1, characterized in that the component (102) comprises one or more protective coatings (178) for protecting a respective transparent cover layer (154) of the separating and/or covering element (132).

10. The component (102) according to claim 1, characterized in that the component (102) is an internal cladding component (116) for a motor vehicle (100), an external cladding component (106) for a motor vehicle (100) or a vehicle window (124) for a motor vehicle (100).

11. A motor vehicle (100) which comprises one or more components (102) in accordance with claim 1.

12. The motor vehicle (100) according to claim 11, characterized in that the component (102) is a windscreen (130) and is arranged on and in particular is fixed to a supporting structure (144) of the motor vehicle (100) by means of the mounting device (146), wherein the motor vehicle (100) preferably comprises a releasing device (208) for releasing the windscreen (130) in the event of a crash.

13. The motor vehicle (100) according to claim 11, characterized in that the motor vehicle (100) comprises a control device by means of which items of information are displayable on one or more indicator devices (180), in particular on one or more display screens (182) of the one or more components (102).

14. A method for the production of a component (102), in particular the component (102) in accordance with claim 1, wherein the method comprises the following:
providing an in particular transparent support element (166);
connecting to the transparent support element (166) and in particular connecting thereto by means of a substance-to-substance bond one or more mounting elements (148) of a mounting device (146) for the purposes of arranging the component (102) on an object (142), in particular on a supporting structure (144) of a motor vehicle (100).

15. A method of operating the motor vehicle (100) according to claim 13, wherein the method comprises the following:
displaying items of information on one or more indicator devices (180) and in particular on one or more display screens (182) of the one or more components (102) of the motor vehicle (100).
